(19) United States
(12) Patent Application Publication
(10) Pub. No.: US 2006/0256995 A1
(43) Pub. Date: Nov. 16, 2006

(54) Speaker apparatus

(75) Inventors: Yasuhisa Abe, Yamagata (JP); Chuichi Endo, Yamagata (JP)

Correspondence Address: SUGHRUE MION, PLLC, 2100 PENNSYLVANIA AVENUE, N.W., SUITE 800, WASHINGTON, DC, 20037, US

(73) Assignees: PIONEER CORPORATION; TOHOKU PIONEER CORPORATION

(21) Appl. No.: 11/410,233

(22) Filed: Apr. 25, 2006

(30) Foreign Application Priority Data
Apr. 25, 2005 (JP) P2005-127200

(51) Int. Cl. H04R 1/02

(52) U.S. Cl. 381/389

(57) ABSTRACT

A speaker apparatus includes a speaker unit including an attaching member; and a cabinet including an inner peripheral surface on which a support groove is formed. The support groove surrounds the attaching member. The speaker unit is fixed to the cabinet by fitting an outer peripheral edge of the attaching member into the support groove. The support groove includes a bottom surface that has a rib portion whose distal end abuts on the outer peripheral edge of the attaching member. The rib portion is formed in a ring-like shape extending over a whole circumference of the support groove.

### BACKGROUND OF THE INVENTION

1. Field of the Invention

The present invention relates to a speaker apparatus wherein a speaker unit is fixed to a cabinet.

2. Description of the Related Art

A speaker unit emits sounds to both a front surface side and a rear surface side of a diaphragm, by the vibration of the diaphragm. However, the sounds emitted by the vibration of the diaphragm to the front surface side and the rear surface side are inverted in phase. Accordingly, when both the sounds are mixed, they cancel each other, and a normal sound is not given forth.

Ordinarily, therefore, the speaker unit is used in a configuration in which a cabinet is attached onto the rear surface side of this speaker unit. The cabinet functions as a housing for supporting the speaker unit, and it also clarifies the sound emitted to the front surface side of the speaker unit, in such a way that the sound emitted to the rear surface side of the speaker unit is prevented from leaking to the front surface side thereof.

Heretofore, the mounting structure of the speaker unit in a speaker apparatus has mostly had a configuration in which the outer peripheral edge of the frame of the speaker unit is screwed to a baffle plate at the front surface of the cabinet.

However, the number of components increases due to screw components, etc., and besides, the enhancement of assemblability is hampered by driving a screw in, so that a structure of fitting type has been proposed (refer to, for example, JP-A-Hei. 7-212883).

As shown in FIG. 1, the speaker unit mounting structure of the fitting type is such that the outer peripheral edge of the frame of a speaker unit 103 (or the outer peripheral edge of a baffle plate on which the speaker unit 103 is mounted) 104 is fitted and held in a support groove 107 which is formed at the inner peripheral surface of a cabinet 106 surrounding the outer peripheral edge 104. This mounting structure can attain an enhancement of a productivity and the reduction of a cost, owing to the decrease of the number of components, the curtailment of the number of process for assemblage, etc. which are based on the fact that the screw components are dispensed with.

### SUMMARY OF THE INVENTION

In the speaker unit mounting structure of the fitting type as stated above, when the fitting is set at clearance fitting in which the thickness dimension of the outer peripheral edge 104 is smaller than the width dimension of the support groove 107, the fitting attachment of the speaker unit 103 to the cabinet 106 can be easily done. However, there has been a problem that, on account of a clearance ascribable to the fitting tolerance between the outer peripheral edge 104 and the support groove 107, a satisfactory airtightness is difficult to be ensured for the fitting part between the outer peripheral edge 104 and the support groove 107, so acoustic characteristics are liable to vary due to air leakage through the clearance of the fitting part.

On the other hand, when the fitting is brought close to tight fitting by making the fitting tolerance small at the fitting part, the clearance which appears at the fitting part can be reduced to suppress the degradation of the acoustic characteristics attributed to sound leakage from the rear of the frame or the baffle plate. However, a fitting operation force is greatly varied even by the slight variance of a dimensional accuracy, so that assemblability worsens. Besides, a working cost increases, or the available percentage of products lowers, to the extent that the dimensional accuracies of the outer peripheral edge 104 and the support groove 107 must be heightened. Accordingly, the cost might increase.

According to such a background, there has been proposed an improved example in which the outer peripheral edge 104 to be fitted into the support groove 107 is provided with a step 104a as shown in FIG. 2, or in which an elastic seal member 108 is interposed at the fitting part as shown in FIG. 3. It is the actual situation, however, that the improved examples have not achieved satisfactory effects for both the enhancement of a seal performance and the enhancement of the assemblability at the fitting part.

The present invention has been made in view of above circumstances and provides the speaker apparatus. According to an aspect of the invention, there is provided the speaker apparatus wherein a speaker unit is fixed to a cabinet by fitting the outer peripheral edge of the frame or baffle plate (attaching member) of the speaker unit into the support groove of the cabinet, in which, even when the fitting tolerance between the width dimension of the support groove and the thickness dimension of the outer peripheral edge is not made small, a seal performance at the fitting part between the support groove and the outer peripheral edge can be enhanced to prevent acoustic characteristics from degrading due to sound leakage at the fitting part, in which the variance of fitting operation forces can be eliminated to enhance assemblability, and in which the seal performance at the fitting part can be enhanced to realize, not only the enhancement of acoustic characteristics, but also the enhancement of a productivity and the reduction of a cost.

According to a first aspect of the invention, there is provided a speaker apparatus including; a speaker unit including an attaching member; and a cabinet including an inner peripheral surface on which a support groove is formed. The support groove surrounds the attaching member. The speaker unit is fixed to the cabinet by fitting an outer peripheral edge of the attaching member into the support groove. The support groove includes a bottom surface that has a rib portion whose distal end abuts on the outer peripheral edge of the attaching member, and the rib portion is formed in a ring-like shape extending over a whole circumference of the support groove. According to a second aspect of the invention, there is provided a speaker apparatus including: a speaker unit including an attaching member; and a cabinet including an inner peripheral surface on which a support groove is formed. The support groove surrounds the attaching member. The speaker unit is fixed to the cabinet by fitting an outer peripheral edge of the attaching member into the support groove. The outer peripheral edge of the attaching member includes a rib portion whose distal end abuts on a bottom surface of the support groove and the rib portion is formed in a ring-like shape extending over a whole circumference of the outer peripheral edge of the attaching member.

In addition, the attaching member may include a baffle plate on which the speaker unit is mounted.

In addition, the attaching member may include a frame of the speaker unit.

In addition, the rib portion may include a plurality of ribs being arranged in an axial direction of the speaker unit.

In addition, the outer peripheral edge of the attaching member and the support groove may be fitted with an elastic seal member interposed therebetween, and the distal end of the rib portion may press the elastic seal member.

### BRIEF DESCRIPTION OF THE DRAWINGS

FIG. 1 is a sectional view of a portion of an example of a support structure for a speaker unit in a speaker apparatus.

FIG. 2 is a sectional view of a portion of an improved example of the support structure for a speaker unit as shown in FIG. 1.

FIG. 3 is a sectional view of a portion of an improved example of the support structure for a speaker unit as shown in FIG. 2.

FIG. 4 is a perspective view of a low-pitched sound reproducing speaker apparatus according to an embodiment of the invention.

FIG. 5 is a front view of the low-pitched sound reproducing speaker apparatus shown in FIG. 4.

FIG. 6 is a sectional view taken along a line A-A in FIG. 5.

FIG. 7 is a sectional view taken along a line B-B in FIG. 5.

FIG. 8 is an enlarged view of a portion D in FIG. 7.

FIG. 9 is a view of the speaker apparatus seen in the direction of an arrow C in FIG. 5.

FIG. 10 is a schematic side view of the low-pitched sound reproducing speaker apparatus shown in FIG. 4, in a state before the speaker apparatus is mounted on a seat of a vehicle.

FIG. 11 is an explanatory view of the low-pitched sound reproducing speaker apparatus shown in FIG. 4, in a state where the speaker apparatus has been mounted on the seat of the vehicle.

FIG. 12 is a perspective view of the low-pitched sound reproducing speaker apparatus shown in FIG. 4, in a state where the speaker apparatus has been mounted on the rear seat of a passenger car.

FIG. 13 is a sectional view of a portion of the fitting structure between a cabinet and the speaker unit in the speaker apparatus according to another embodiment of the invention.

FIG. 14 is a sectional view of a portion of the fitting structure between the cabinet and the speaker unit in the speaker apparatus according to the still another embodiment of the invention.

FIG. 15 is a sectional view of a portion showing an embodiment of the invention as is provided with a plurality of ribs.

FIG. 16 is a sectional view of a portion showing an embodiment of the invention as has a configuration in which ribs erected on the bottom part of a support groove and a rib erected on the outer peripheral surface of an outer peripheral edge are coexistent.

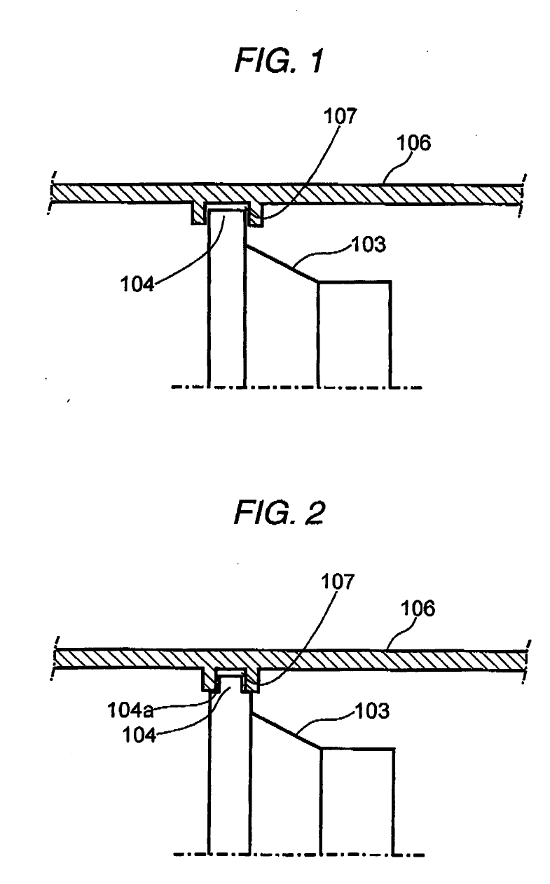

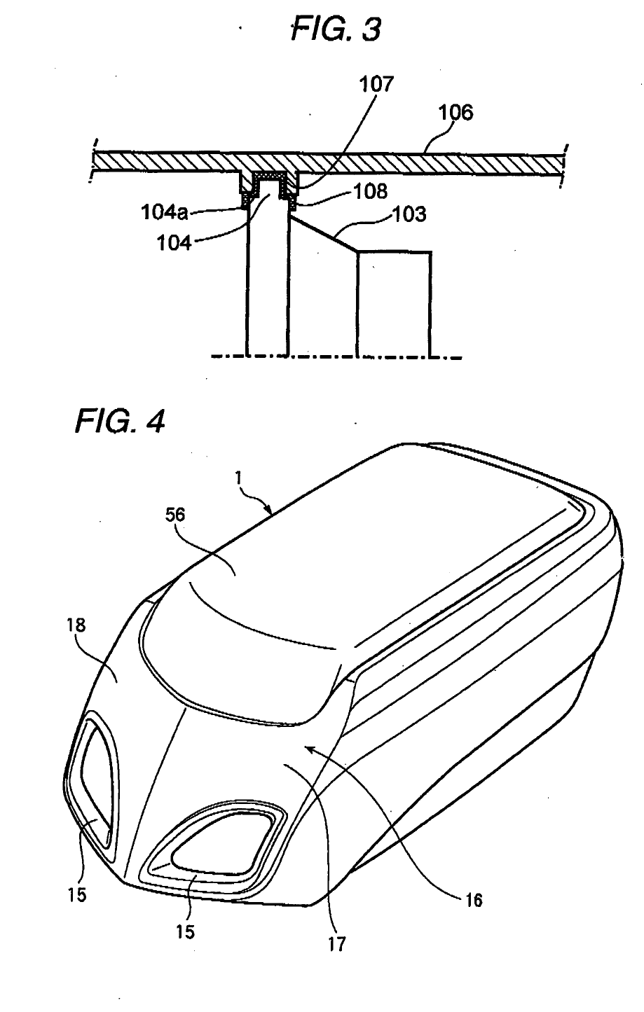

### DETAILED DESCRIPTION OF THE INVENTION

Now, embodiments of a low-pitched sound reproducing speaker apparatus according to the present invention will be described in detail with reference to the drawings.

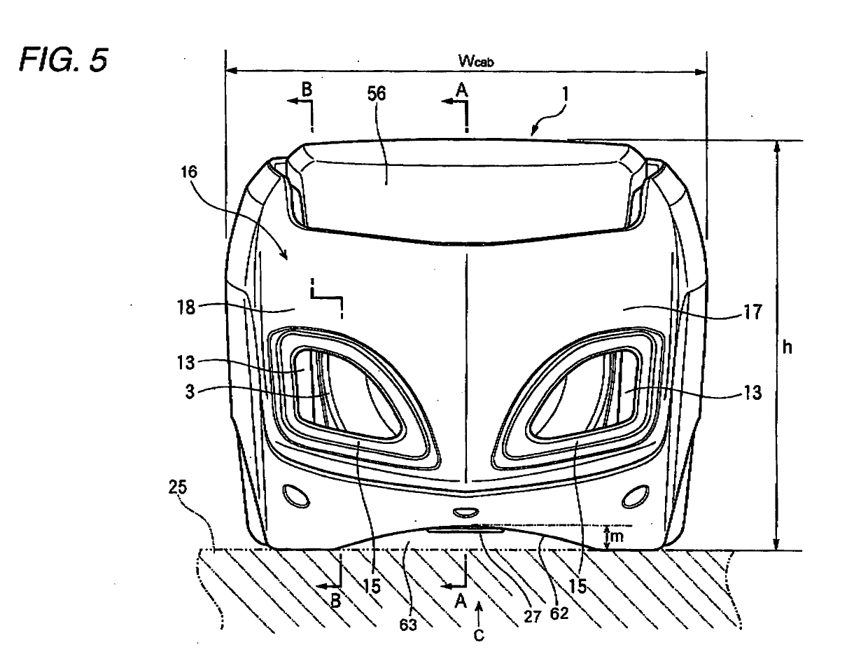

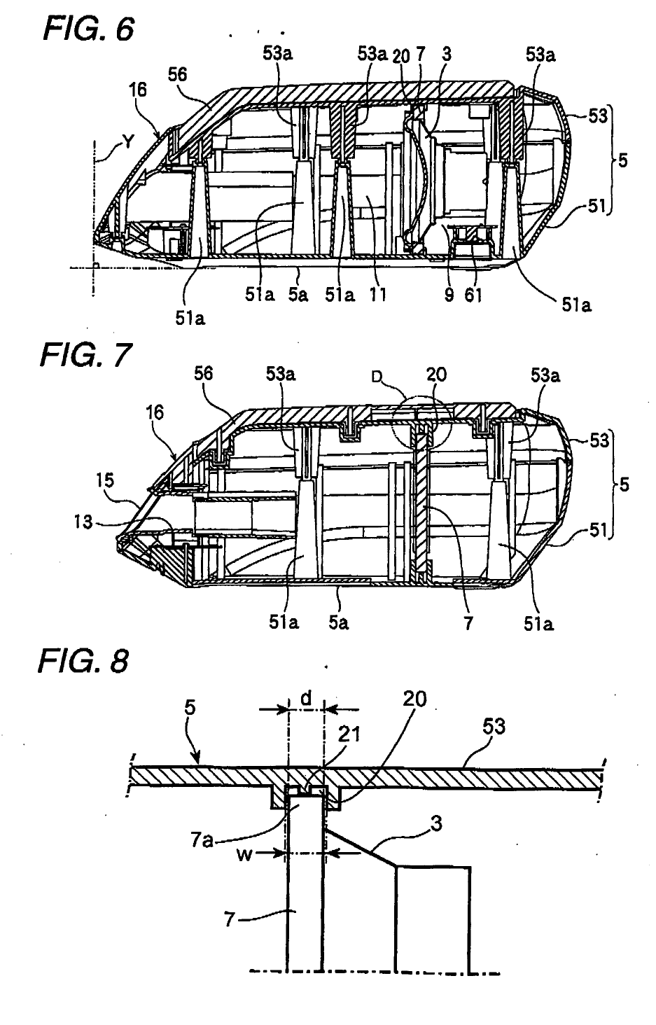

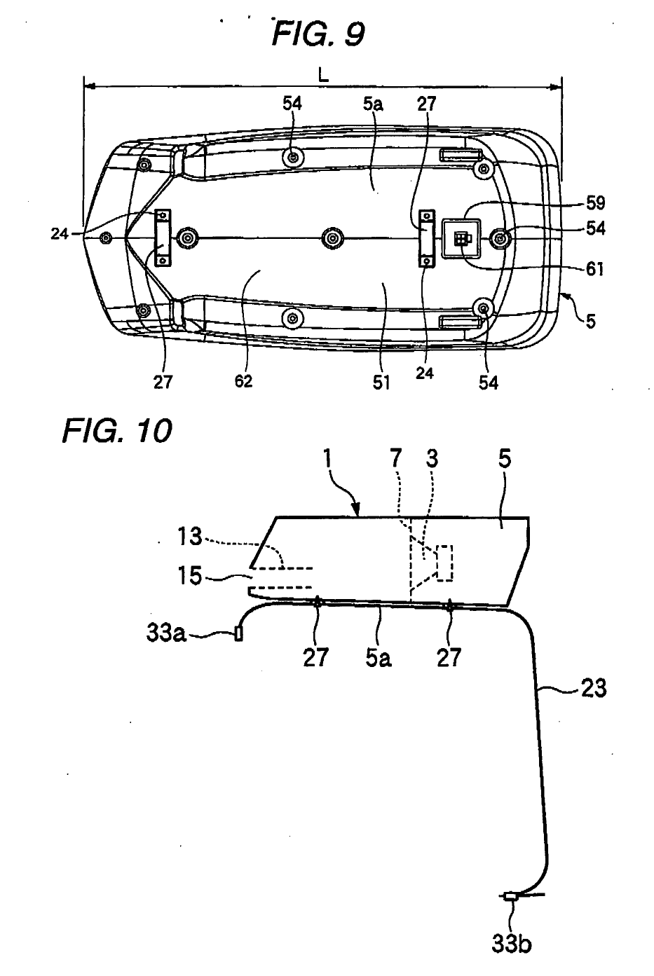

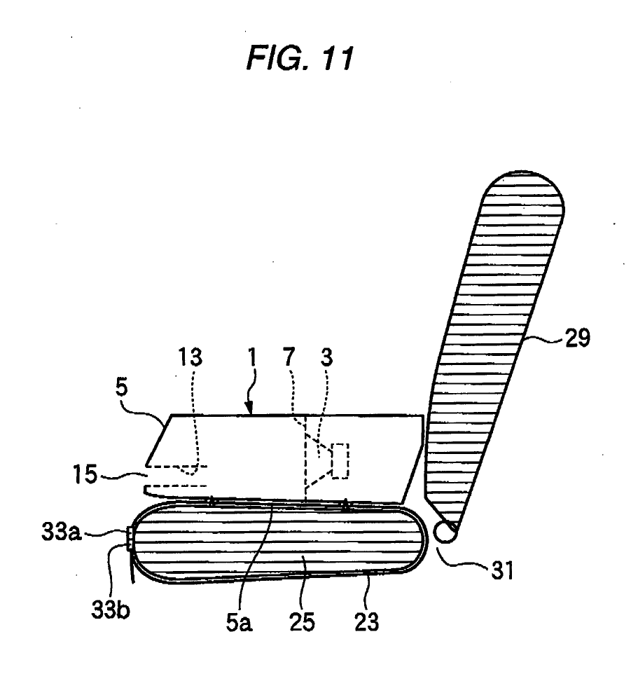

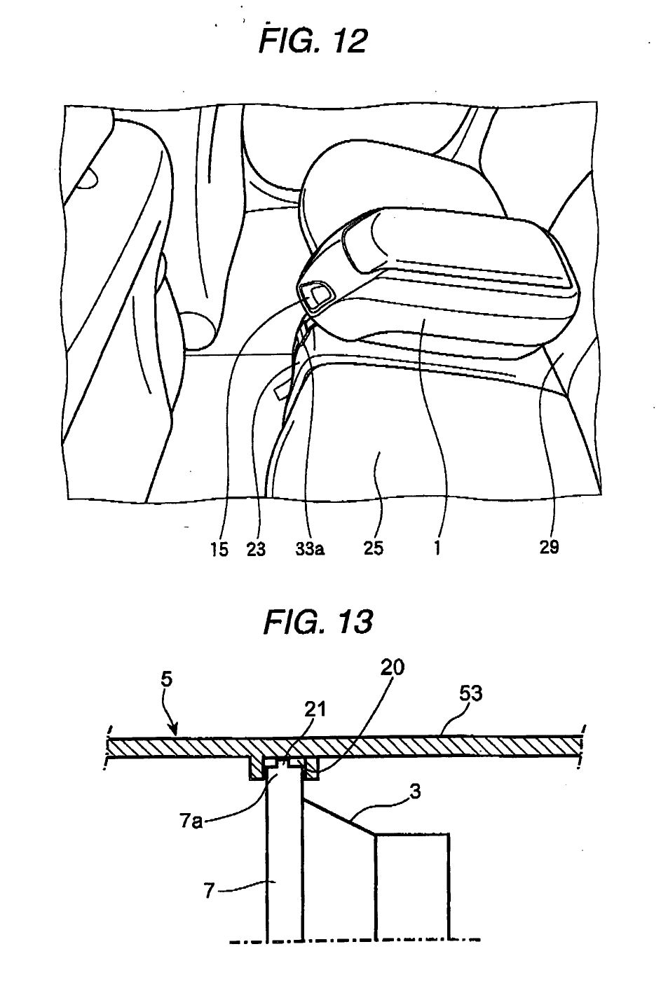

FIG. 4 is a perspective view of the speaker apparatus according to an embodiment of the invention, FIG. 5 is a front view of the speaker apparatus shown in FIG. 4, FIG. 6 is a sectional view taken along a line A-A in FIG. 5, FIG. 7 is a sectional view taken along a line B-B in FIG. 5, FIG. 8 is an enlarged view of a portion D in FIG. 7, FIG. 9 is a view of the speaker apparatus seen in the direction of an arrow C in FIG. 5, FIG. 10 is a schematic side view of the speaker apparatus shown in FIG. 4, in a state before the speaker apparatus is mounted on the seat of a vehicle, FIG. 11 is an explanatory view of the speaker apparatus shown in FIG. 4, in a state where the speaker apparatus has been mounted on the seat of the vehicle, and FIG. 12 is a perspective view of the speaker apparatus shown in FIG. 4, in a state where the speaker apparatus has been mounted on the rear seat of a passenger car.

The speaker apparatus 1 of this embodiment is the low-pitched sound reproducing speaker apparatus of Kelton type which is connected to an on-vehicle sound system as a subwoofer. It is configured of a speaker unit 3, and a cabinet 5 which houses the speaker unit 3 therein.

As shown in FIGS. 6 and 7, the interior of the cabinet 5 is separated into a first air chamber 9 sealing the rear surface of the speaker unit 3 and a second air chamber 11 surrounding the front surface of the speaker unit 3, by a partition plate (baffle plate (attaching member)) 7 to which the speaker unit 3 is attached. Besides, that front wall 16 of the cabinet 5 which forms the second air chamber 11 is provided with ducts 13 and ports 15 which emit to the exterior, only the low-pitched sound of specified frequency band in a sound wave generated within the second air chamber 11 by the speaker unit 3.

The cabinet 5 is a vessel being substantially in the shape of a rectangular parallelepiped which is elongate in a frontward and rearward direction. As shown in FIG. 9, the length dimension L of the cabinet 5 in the frontward and rearward direction is set at, for example, 435 mm being a value which is substantially near to the depth dimension of the seat cushion (sitting portion) of the vehicle.

Besides, as shown in FIG. 6, that front wall 16 of the cabinet 5 which is provided with the ducts 13 and the ports 15 is set as a wall which inclines at a predetermined angle to a vertical plane Y orthogonal to the lower surface 5a or the cabinet 5. Concretely, the front wall 16 is in a slant shape which inclines down frontward. Besides, as shown in FIGS. 4 and 5, the front wall 16 has a bilaterally symmetric structure, which includes left and right inclining walls 17 and 18 that incline back outwards from the widthwise center line of the cabinet 5. Here, each of the left and right inclining walls 17 and 18 is provided with the duct 13 and the port 15.

The partition plate 7 is in the shape of a thick plate which has a strength sufficient for supporting the speaker unit 3. As shown in FIG. 7, the partition plate 7 is supported substantially perpendicularly to the cabinet lower surface 5a in such a way that the outer peripheral edge 7a is fitted in a support groove 20 which is formed at the inner periphery of the cabinet 5.

As shown in FIG. 6, the partition plate 7 supports the speaker unit 3 with the front surface thereof facing to the front side of the cabinet 5, and it separates the interior of the cabinet 5 into the two, front and rear air chambers 11 and 9.

In case of this embodiment, the support groove 20 is a groove which is formed over the whole inner periphery of the cabinet 5 so as to fit the whole outer peripheral edge 7a of the partition plate 7 into this groove. As shown in FIG. 8, the width dimension w of the support groove 20 is set to be slightly larger than the thickness dimension d of the outer peripheral edge 7a of the partition plate 7, in order that the fitting between the support groove 20 and the partition plate 7 may become clearance fitting.

Besides, as shown in FIG. 8, a rib 21 (rib portion) whose distal end abuts on the outer peripheral surface of the outer peripheral edge 7a of the partition plate 7 fitted in the support groove 20 is erected on the bottom surface of the support groove 20 in a ring-like shape which extends over the whole circumference of the groove 20.

The rib 21 has its distal end held in abutment on the outer peripheral surface of the outer peripheral edge 7a, thereby to airtightly cut off a minute clearance which is defined between the outer peripheral edge 7a and the support groove 20.

As shown in FIGS. 10 through 12, the speaker apparatus 1 of this embodiment has the cabinet 5 fixed to the seat cushion 25 of the vehicle in such a way that a fixing belt 23 laid in the front and rear direction on the cabinet lower surface 5a is bound to the seat cushion 25.

As shown in FIG. 10, the fixing belt 23 is a belt member which is formed of the same texture as that of the seat belt or the like of the vehicle. Both the ends of the fixing belt 23 are respectively provided with connection buckles 33a and 33b of one-touch type which connect both these ends to each other.

As shown in FIG. 9, belt keeping brackets 27 made of metal plates are fixed in two, front and rear places on the widthwise center line of the cabinet 5, on the lower surface 5a of this cabinet 5, in such a manner that each of them is fastened with two screws 24. Each of the belt keeping brackets 27 forms a belt insertion hole between each of the belt keeping brackets 27 and the lower surface 5a, so as to fix the fixing belt 23 inserted through the belt insertion hole, onto the cabinet lower surface 5a.

As shown in FIG. 11, the fixing belt 23 fixed to the cabinet lower surface 5a is detachably clamped and fixed to the seat cushion 25 in such a way that one end of this belt 23 is passed through the gap 31 between the seat cushion 25 and a seatback 29 and is pulled around the seat cushion 25 to the front side thereof, and that both the ends of this belt 23 are detachably connected by the one-touch type connection buckles 33a and 33b or the likes.

As shown in FIG. 5, the cabinet 5 thus far described has its width dimension Wcab set at a value (for example, at most 210 mm) which is smaller than the width of a passage (walk-through) formed between the right and left seats of the vehicle. Besides, the height dimension h of the cabinet 5 is set at, for example, 175 mm or so. The geometries of the cabinet 5 as described above are set so that the speaker apparatus 1 can be utilized as an arm rest when mounted on the rear seat of the passenger car, and that the speaker apparatus 1 can be moved into the passage between the driver's seat and assistant driver's seat of the vehicle, or the like when demounted from the seat.

In the case of this embodiment, as shown in FIGS. 6 through 9, the cabinet 5 is formed in a manner to be vertically divided into a lower case 51 in which the fixing belt 23 is detachably attached to the lower surface 5a, and an upper case 53 which covers the upper part of the lower case 51.

Both the lower case 51 and the upper case 53 are formed by the injection molding of a synthetic resin.

Besides, the lower case 51 and the upper case 53 are respectively provided with connection struts 51a and 53a at suitable intervals so as to traverse the middle parts of the air chambers 9 and 11. The connection struts 51a and 53a are connected to each other with their distal ends held in abutment, thereby to bear the load of the speaker apparatus 1 in the up and down direction thereof.

As shown in FIG. 9, the connection struts 51a formed in the lower case 51 is formed with hollow parts through which screws 54 are inserted from the side of the lower surface 5a. Besides, female screws with which the screws 54 are threadably engaged are formed at those distal ends of the connection struts 53a which are brought into abutment on the distal ends of the connection struts 51a, and the lower case 51 and the upper case 53 are coupled by tightening the screws 54.

Besides, in the speaker apparatus 1 of this embodiment, a cushion member 56 is stuck on the upper surface of the upper case 53 constituting the cabinet 5. The cushion member 56 is a decorating outer cover, and it can be prepared as a molded article made of a foamed resin or the like which is richer in elasticity than the resin forming the lower case 51 and the upper case 53, or as a structure in which a sponge member of higher pliability is surrounded with a synthetic leather, a genuine leather, or the like.

In the case of this embodiment, as also shown in FIG. 4, the front wall 16 which is provided with the ducts 13 and the ports 15 is formed unitarily with the upper case 53 as the front wall of this upper case 53. The duct 13 and the port 15 in one pair are provided in each of the arrayed left and right inclining walls 17 and 18, and the ducts 13 and the ports 15 totaling two pairs are provided in the two, left and right places.

Besides, in the case of the speaker apparatus 1 of this embodiment, an amplifier which amplifies an input signal to the speaker unit 3 is attached as a separate unit outside the cabinet 5. Therefore, an input terminal 61 for joining an output line from the amplifier is provided in a recess 59 on the rear side of the lower surface 5a of the cabinet 5.

Besides, in the case of this embodiment, as shown in FIG. 5, the cabinet lower surface 5a is formed into a concave curved surface 62 which is concave at a middle part relative to both sides in the widthwise direction of the cabinet 5.

Here, as shown in FIG. 9, the concave curved surface 62 is provided in the shape of a watershoot which extends along the front and rear direction of the cabinet 5, and a cavity 63 which the concave curved surface 62 forms between it and the seat cushion 25 is open in the front and rear direction of the cabinet 5.

Incidentally, the concave curved surface 62 is a circular arc surface whose concavity magnitude becomes the maximum at the central position of the cabinet 5 in the widthwise direction thereof. As shown in FIG. 5, the concavity magnitude m at the widthwise central position of the cabinet 5 is set to be larger than the magnitude of the protrusion of each belt keeping bracket 27 onto the side of the seat cushion 25. Accordingly, the belt keeping brackets 27 do not touch the seat cushion 25.

In the speaker apparatus 1 described above, the speaker unit 3 is fixed to the cabinet 5 by fitting into the support groove 20 of the cabinet 5, the outer peripheral edge 7a of the partition plate 7 to which this speaker unit 3 has been fixed. Here, the rib 21 erected on the bottom surface of the support groove 20 has its distal end held in abutment on the outer peripheral surface of the outer peripheral edge 7a, and it airtightly cuts off the minute clearance defined between the outer peripheral edge 7a and the support groove 20.

Accordingly, even when the fitting tolerance between the width dimension w of the support groove 20 and the thickness dimension d of the outer peripheral edge 7a of the partition plate 7 is not made small, a seal performance at the fitting part between the support groove 20 and the outer peripheral edge 7a is enhanced, and acoustic characteristics can be prevented from degrading due to sound leakage through the fitting part.

Further, even when the fitting tolerance between the width dimension w of the support groove 20 and the thickness dimension d of the outer peripheral edge 7a of the partition plate 7 is relaxed or mitigated, the seal performance at the fitting part is not apprehended to lower, and hence, the operation of fitting the outer peripheral edge 7a and the support groove 20 can be facilitated by loosing the fitting tolerance between the width dimension w of the support groove 20 and the thickness dimension d of the outer peripheral edge 7a of the partition plate 7. Besides, assemablability can be enhanced by eliminating a variance in fitting operation forces in the case of fitting the outer peripheral edge 7a into the support groove 20.

Moreover, since the seal performance at the fitting part can be enhanced without adding any dedicated component or the like, the number of components and the number of process for the assemblage can be prevented from increasing.

After all, not only the enhancement of the acoustic characteristics due to the enhancement of the seal performance at the fitting part can incarnate, but also the enhancement of a productivity and the reduction of a cost can be achieved.

By the way, in the speaker apparatus or the invention, the position at which the rib 21 is provided is not restricted to the bottom surface of the support groove 20.

As shown in FIG. 13, the rib 21 may well be erected on the outer peripheral surface of the partition plate 7.

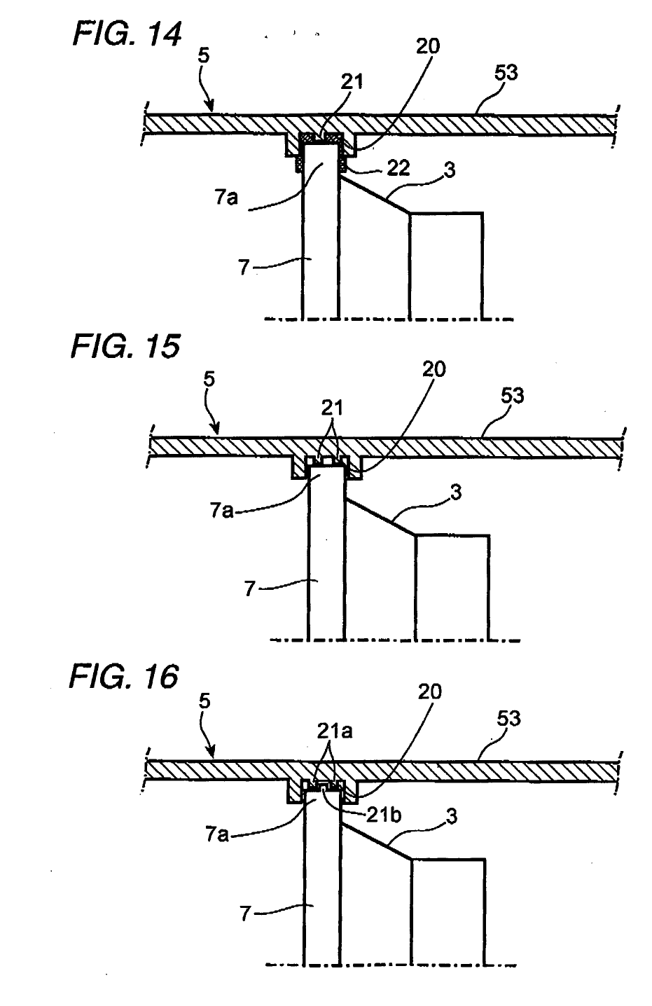

Further, as shown in FIG. 14, the outer peripheral edge 7a of the partition plate 7 and the support groove 20 may well be assembled as a fitting structure in which they are fitted with an elastic seal member (cushion member) 22 interposed therebetween, and in which the distal end of the rib 21 presses the elastic seal member 22.

The elastic seal member 22 is, for example, a packing member made of a synthetic rubber as is fitted in the support groove 20 in close contact with the inner surface thereof. The distal end of the rib 21 bites into the elastic seal member 22, whereby a seal performance at the fitting part is further enhanced, and further enhancement in the acoustic characteristics can be attained.

By the way, in each of the embodiments, the rib 21 is provided in one place. However, if possible in dimensions, a plurality of ribs 21 may well be provided in the axial direction of the speaker unit 3 (an example in which two ribs 21 are provided, is shown in FIG. 15). In this way, the number of the places for airtightly cutting off the clearance is increased, and hence, the reliability of the seal performance at the fitting part is enhanced.

Besides, as shown in FIG. 16, in the case of providing the plurality of ribs 21, it also may be possible to adopt a configuration in which ribs 21a erected on the bottom part of the support groove 20 and a rib 21b erected on the outer peripheral surface of the outer peripheral edge 7a are coexistent.

In this manner, the plurality of ribs 21 are distributively provided at both the bottom part of the support groove 20 and the outer peripheral edge 7a of the partition plate 7, whereby a complicated structure in which the ribs 21 are close to each other within a narrow range can be avoided on each of the components, and the manufacture of each of the components can be facilitated.

Besides, the embodiments have such a structure that the outer peripheral edge of the baffle plate (partition plate 7) on which the speaker unit 3 is mounted is fitted into the support groove 20 at the inner periphery of the cabinet 5.

However, in a case where the baffle plate is omitted by reason of reduction in the size of the cabinet, or the like, a structure in which the speaker unit is fixed to the cabinet can be incarnated by fitting the outer peripheral edge of the frame (attaching member) of the speaker unit into the support groove. Also in this case, the ribs 21 whose distal end s abut on the opposite side may be provided on the outer peripheral surface of the frame and/or the bottom surface of the support groove.

As described above in detail, in the speaker apparatus 1 according to each of the embodiments of the invention wherein the outer peripheral edge 7a of a partition plate 7 being a baffle plate on which a speaker unit 3 is mounted, or that of the frame of the speaker unit is fitted into a support groove 20 which is formed at the inner peripheral surface of a cabinet 5 surrounding the outer peripheral edge 7a, whereby the speaker unit 3 is fixed to the cabinet 5, and one side of the speaker unit 3 is tightly closed by the cabinet 5. Also, at least either of the bottom surface of the support groove 20 and the outer peripheral edge 7a of the partition plate 7 is provided with a rib 21 whose distal end abuts on the opposing surface of the opposite side, in the ring-like shape which extends over the whole circumference of the support groove 20.

Thus, airtightness at the fitting part between the support groove 20 and the outer peripheral edge 7a can be enhanced by the abutting force of the distal end of the rib 21, not by the forces of both the side surfaces of the support groove 20 sandwiching the outer peripheral edge 7a therebetween. Therefore, even when the fitting tolerance between the width dimension w of the support groove 20 and the thickness dimension d of the outer peripheral edge 7a of the partition plate 7 is not made small, a seal performance at the fitting part is enhanced, and acoustic characteristics can be prevented from degrading due to sound leakage at the fitting part.

Besides, owing to the loosing of the fitting tolerance, assemblability can be enhanced to attain enhancement in a productivity.

Moreover, since the seal performance at the fitting part can be enhanced without adding any dedicated component or the like, the number of components and the number of for the assemblage can be prevented from increasing.

The entire disclosure of Japanese Patent Application No. 2005-127200 filed on Apr. 25, 2005 including specification, claims, drawings and abstract is incorporated herein be reference in its entirety.

What is claimed is:

1. A speaker apparatus comprising:
a speaker unit including an attaching member; and
a cabinet including an inner peripheral surface on which a support groove is formed, the support groove surrounding the attaching member,
wherein the speaker unit is fixed to the cabinet by fitting an outer peripheral edge of the attaching member into the support groove; and
wherein the support groove includes a bottom surface that has a rib portion whose distal end abuts on the outer peripheral edge of the attaching member, the rib portion being formed in a ring-like shape extending over a whole circumference of the support groove.

2. The speaker apparatus according to claim 1,
wherein the attaching member includes a baffle plate on which the speaker unit is mounted.

3. The speaker apparatus according to claim 1,
wherein the attaching member includes a frame of the speaker unit.

4. The speaker apparatus according to claim 1,
wherein the rib portion includes a plurality of ribs being arranged in an axial direction of the speaker unit.

5. The speaker apparatus according to claim 1,
wherein the outer peripheral edge of the attaching member and the support groove are fitted with an elastic seal member interposed therebetween, and
wherein the distal end of the rib portion presses the elastic seal member.

6. The speaker apparatus according to claim 1,
wherein the cabinet seals the space which is surrounded by the cabinet and one side of the speaker unit.

7. A speaker apparatus comprising:
a speaker unit including an attaching member; and
a cabinet including an inner peripheral surface on which a support groove is formed, the support groove surrounding the attaching member,
wherein the speaker unit is fixed to the cabinet by fitting an outer peripheral edge of the attaching member into the support groove; and
wherein the outer peripheral edge of the attaching member includes a rib portion whose distal end abuts on a bottom surface of the support groove, the rib portion being formed in a ring-like shape extending over a whole circumference of the outer peripheral edge of the attaching member.

8. The speaker apparatus according to claim 7,
wherein the attaching member includes a baffle plate on which the speaker unit is mounted.

9. The speaker apparatus according to claim 7,
wherein the attaching member includes a frame of the speaker unit.

10. The speaker apparatus according to claim 7,
wherein the rib portion includes a plurality of ribs being arranged in an axial direction of the speaker unit.

11. The speaker apparatus according to claim 7,
wherein the outer peripheral edge of the attaching member and the support groove are fitted with an elastic seal member interposed therebetween, and
wherein the distal end of the rib portion presses the elastic seal member.

12. The speaker apparatus according to claim 7,
wherein the cabinet seals the space which is surrounded by the cabinet and one side of the speaker unit.
